(19) United States
(12) Patent Application Publication
(10) Pub. No.: US 2025/0289329 A1
(43) Pub. Date: Sep. 18, 2025

(54) POWER RECEPTION DEVICE

(71) Applicant: HONDA MOTOR CO., LTD., Tokyo (JP)

(72) Inventor: Seiichiro KONDO, Tokyo (JP)

(73) Assignee: HONDA MOTOR CO., LTD., Tokyo (JP)

(21) Appl. No.: 19/062,041

(22) Filed: Feb. 25, 2025

(30) Foreign Application Priority Data
Mar. 18, 2024 (JP) 2024-041916

(51) Int. Cl. B60L 53/122; B60L 53/22; B60L 53/66; H02J 50/12

(52) U.S. Cl. CPC B60L 53/122; B60L 53/22; B60L 53/66; H02J 50/12; B60L 2210/30; B60L 2210/40

(57) ABSTRACT

A power reception device including a power reception unit which receives power transmitted from a power transmission device by contactless power transmission, a power supply unit which is allowed to be charged with power received by the power reception unit and allowed to supply stored power to a load, a detection unit which detects a terminal voltage of the power supply unit, and a control unit which controls a variable capacitance of the power supply unit based on a change amount of the terminal voltage detected by the detection unit.

### CROSS-REFERENCE TO RELATED APPLICATIONS

This application is based on and claims priority under 35 USC 119 from Japanese Patent Application No. 2024-041916 filed on Mar. 18, 2024, the entire content of which is incorporated herein by reference.

### TECHNICAL FIELD

The technique of the present disclosure relates to a power reception device.

### BACKGROUND ART

In recent years, researches and developments have been conducted on charging and power feeding in a vehicle mounted with a secondary battery that contributes to an increase in energy efficiency in order to allow more users to access affordable, reliable, sustainable, and advanced energy.

For example, as researches and developments related to charging and power feeding, researches and developments related to contactless power transmission in which power is contactlessly transmitted between two devices have been conducted.

JP2017-147849A discloses a contactless power feeding device including a power feeding unit and a power reception unit, in which the power feeding unit includes a power feeding coil and an alternating current power supply that supplies alternating current power to the power feeding coil, and the power reception unit includes a power reception coil that contactlessly receives the alternating current power by being electromagnetically coupled to the power feeding coil when facing the power feeding coil, a power-receiving-side resonant capacitor that is connected to the power reception coil and forms a power-receiving-side resonant circuit, a power reception circuit that converts the alternating current power received by the power reception coil to generate a power reception voltage and outputs the power reception voltage to an electrical load, and an over-voltage protection circuit that changes a power-receiving-side resonant frequency of the power-receiving-side resonant circuit when the power reception voltage exceeds a threshold voltage for determining an over-voltage state.

JP2017-175703A discloses a wireless power reception device that is mounted on a moving object that obtains a driving force from power stored in a battery and is capable of wirelessly receiving power while the moving object is moving or stopped.

JP2013-005615A discloses a power reception device for contactlessly receiving power transferred from a power transmission device by electromagnetic resonance.

JP2022-039628A discloses a contactless charging system that includes a relay device and is capable of preventing an overcurrent and an over-voltage of an output of an inverter even when a mutual inductance between a relay coil and a power reception coil varies greatly.

### SUMMARY OF INVENTION

An object of the technique of the present disclosure is to perform optimum power transmission control regardless of an individual difference, a mutual positional relationship, or the like between a power transmission device and a power reception device.

An aspect of the present disclosure relates to a power reception device including:
a power reception unit configured to receive power transmitted from a power transmission device by contactless power transmission;
a power supply unit configured to be allowed to be charged with power received by the power reception unit, and allowed to supply stored power to a load, a capacitance of the power supply unit being variable;
a detection unit configured to detect a terminal voltage of the power supply unit; and
a control unit configured to control the capacitance of the power supply unit based on a change amount of the terminal voltage detected by the detection unit.

According to the aspect of the present disclosure, it is possible to perform optimum power transmission control regardless of an individual difference, a mutual positional relationship, or the like between the power transmission device and the power reception device.

### BRIEF DESCRIPTION OF DRAWINGS

Exemplary embodiment(s) of the present invention will be described in detail based on the following figures, wherein:

FIG. 1 is a schematic diagram illustrating a contactless power transmission system 100 according to an embodiment of the technique of the present disclosure;

FIG. 2 is a schematic diagram illustrating an operation state of the contactless power transmission system 100 during execution of power feeding control by a vehicle-mounted device 10;

FIG. 3 is a diagram illustrating a configuration example of a variable capacitor 34; and

FIG. 4 is a diagram illustrating a modification of the variable capacitor 34.

### DESCRIPTION OF EMBODIMENTS

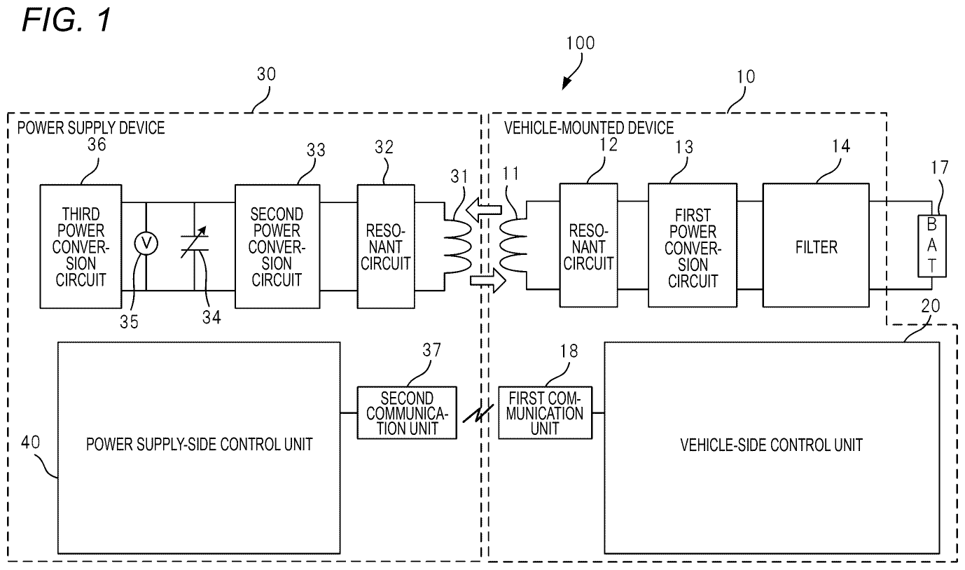

FIG. 1 is a schematic diagram illustrating a contactless power transmission system 100 according to an embodiment of the technique of the present disclosure. The contactless power transmission system 100 includes a vehicle-mounted device 10 mounted on a vehicle or the like, and a power supply device 30 provided in a parking lot, a facility, a house, or the like. The contactless power transmission system 100 is configured to be able to perform first power transmission from the vehicle-mounted device 10 to the power supply device 30. The vehicle-mounted device 10 and the power supply device 30 perform contactless power transmission using magnetic coupling between coils of, for example, a magnetic resonance method or an electromagnetic induction method.

The vehicle on which the vehicle-mounted device 10 is mounted includes a secondary battery 17 (denoted as BAT in the figure) such as a lithium-ion battery or a nickel-hydrogen battery, and includes an electric motor as a drive source driven by power of the secondary battery 17. For example, the vehicle is an automobile including wheels (none illustrated) including drive wheels driven by power of the electric motor and driven wheels that can be steered.

The vehicle-mounted device 10 includes a vehicle-side coil 11, a resonant circuit 12 connected to the vehicle-side coil 11, a first power conversion circuit 13 connected to the resonant circuit 12, a filter 14 provided between the first power conversion circuit 13 and the secondary battery 17, a first communication unit 18, and a vehicle-side control unit 20.

The resonant circuit 12 includes, for example, a capacitor connected in series to the vehicle-side coil 11. During the first power transmission, the vehicle-side coil 11 and the resonant circuit 12 constitute a power transmission unit that transmits power to the power supply device 30 by contactless power transmission.

During the first power transmission, the first power conversion circuit 13 generates supply power to be supplied to the vehicle-side coil 11 and the resonant circuit 12 using the power of the secondary battery 17, and supplies the supply power to the vehicle-side coil 11 and the resonant circuit 12. The first power conversion circuit 13 includes a switching element such as a transistor, and operates, for example, as an inverter that converts a direct current supplied from the secondary battery 17 into a high-frequency alternating current during the first power transmission. The high-frequency alternating current converted by the first power conversion circuit 13 is input to the vehicle-side coil 11, and a high-frequency alternating current is induced by an electromagnetic induction effect in a power supply-side coil 31 of the power supply device 30 facing the vehicle-side coil 11 with a gap therebetween.

The filter 14 is provided to stabilize power and remove noise.

The first communication unit 18 is an interface for performing near field wireless communication. For the near field wireless communication, for example, Wi-Fi (Registered trademark), Bluetooth (Registered trademark), or the like can be used.

The vehicle-side control unit 20 includes a processor such as a central processing unit (CPU) and a memory, and executes various controls related to power transmission.

The power supply device 30 includes the power supply-side coil 31, a resonant circuit 32 connected to the power supply-side coil 31, a second power conversion circuit 33 connected to the resonant circuit 32, a variable capacitor 34 having a variable capacitance connected to the second power conversion circuit 33, a voltage detection circuit 35 configured to detect a terminal voltage Vc of the variable capacitor 34, a third power conversion circuit 36 connected to the variable capacitor 34, a second communication unit 37, and a power supply-side control unit 40.

The resonant circuit 32 includes, for example, a capacitor connected in series to the power supply-side coil 31. During the first power transmission, the power supply-side coil 31 and the resonant circuit 32 constitute a power reception unit that receives power transmitted from the vehicle-mounted device 10 by the contactless power transmission.

The second power conversion circuit 33 operates as a rectifier during the first power transmission, and converts a high-frequency alternating current input from the power supply-side coil 31 into a direct current.

The variable capacitor 34 is charged with the direct current converted by the second power conversion circuit 33. During the first power transmission, the variable capacitor 34 is configured to be able to supply the stored power to a load connected to the third power conversion circuit 36.

The third power conversion circuit 36 operates as an inverter during the first power transmission, and converts a direct current discharged from the variable capacitor 34 into an alternating current having a frequency of a commercial power supply. The alternating current having a commercial frequency converted by the third power conversion circuit 36 is supplied to a load such as a power grid or a home appliance.

The second communication unit 37 is an interface for performing near field wireless communication. For the near field wireless communication, for example, Wi-Fi (Registered trademark), Bluetooth (Registered trademark), or the like can be used.

The power supply-side control unit 40 includes a processor such as a central processing unit (CPU) and a memory, and executes overall control on the power supply device 30.

During the first power transmission, the vehicle-side control unit 20 acquires information about the terminal voltage Vc of the variable capacitor 34 of the power supply device 30, and executes power feeding control for controlling the supply power supplied to the vehicle-side coil 11 and the resonant circuit 12 via the first power conversion circuit 13 such that the terminal voltage Vc comes to a predetermined target voltage. 10

In this way, the vehicle-side control unit 20 uses a system (a charging system including the resonant circuit 12, the vehicle-side coil 11, the power supply-side coil 31, the resonant circuit 32, and the second power conversion circuit 33, which are provided between the first power conversion circuit 13 and the variable capacitor 34) that charges the variable capacitor 34 with the power transmitted from the vehicle-mounted device 10 as a control target to control input power (feedback control) of the control target such that an output voltage (synonymous with the terminal voltage Vc) of the control target comes to a target voltage. Hereinafter, a transfer function of the control target is referred to as a transfer function G(s).

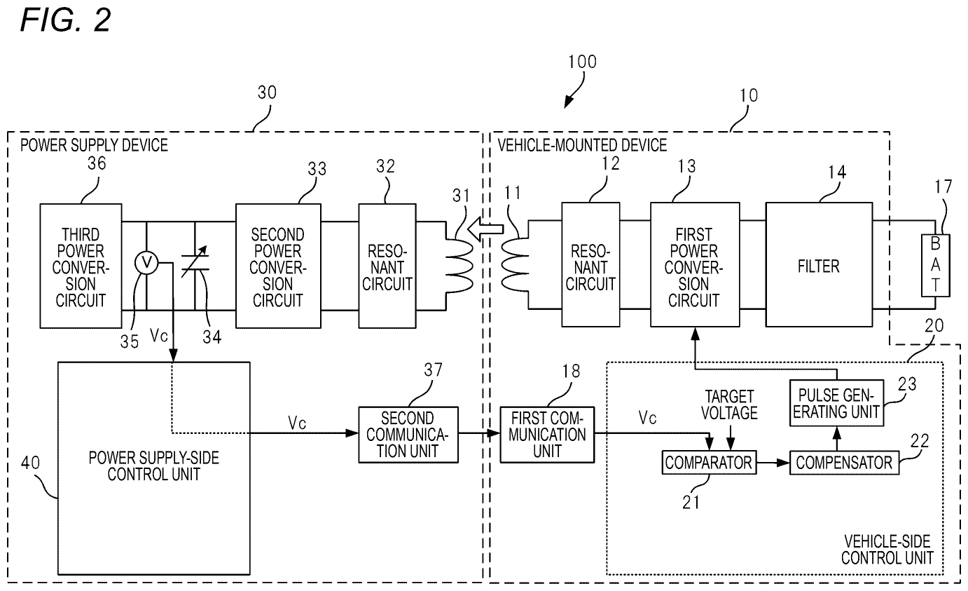

FIG. 2 is a schematic diagram illustrating an operation state of the contactless power transmission system 100 during execution of power feeding control by the vehicle-mounted device 10. When the power feeding control is started, the power supply-side control unit 40 acquires information about the terminal voltage Vc from the voltage detection circuit 35 and executes control to transmit the acquired information about the terminal voltage Vc from the second communication unit 37 to the vehicle-mounted device 10. The terminal voltage Vc transmitted from the second communication unit 37 is received by the first communication unit 18 and acquired by the vehicle-side control unit 20.

As illustrated in FIG. 2, the vehicle-side control unit 20 includes a comparator 21, a compensator 22, and a pulse generating unit 23. These are configured by hardware, software, or a combination thereof. The comparator 21 compares the terminal voltage Vc acquired by the first communication unit 18 with the target voltage, and outputs a deviation therebetween.

The compensator 22 determines, based on the deviation input from the comparator 21 and various preset setting values (for example, information on P term, I term, and D term in the case of a PID compensator), input power to the control target required for optimizing the output of the control target represented by the transfer function G(s) (achieving a state with good responsiveness and no oscillation).

Specifically, the compensator 22 determines the input power to the control target such that a phase margin between the input and the output of the control target is 0 degree or more. The pulse generating unit 23 generates a drive pulse and supplies the drive pulse to the first power conversion circuit 13 such that the power output from the first power conversion circuit 13 comes to the input power determined by the compensator 22.

If respective values (frequencies) of a pole and a zero in the transfer function G(s) are determined, the setting value of the compensator 22 at which the phase margin between the input and the output of the control target is 0 degree or more can be determined based on the values.

The transfer function G(s) can be uniquely determined if the combination of the vehicle-mounted device 10 and the power supply device 30 is fixed. However, even with this combination, the transfer function G(s) may vary depending on a positional relationship between the vehicle-side coil 11 and the power supply-side coil 31, an individual difference in the device, an external environment, and the like. The capacitance of the variable capacitor 34 of the power supply device 30 is required to be an appropriate value according to the transfer function G(s) determined by the combination of the vehicle-mounted device 10 and the power supply device 30. However, as described above, when a change occurs in the transfer function G(s) uniquely determined by design information of each of the vehicle-mounted device 10 and the power supply device 30, the capacitance of the variable capacitor 34 may not be appropriate. Therefore, in the present embodiment, the capacitance of the variable capacitor 34 can be set to an appropriate value by using the output of the control target when the control target is operated under a specific condition.

Before the power feeding control is executed, that is, at a timing before the supply power to the vehicle-side coil 11 and the resonant circuit 12 is determined by the comparator 21 and the compensator 22, the vehicle-side control unit 20 executes capacitance setting control in which a drive pulse having a predetermined pattern (a pattern with a fixed pulse width and fixed frequency) is generated by the pulse generating unit 23, and the first power conversion circuit 13 is controlled in accordance with the drive pulse to control the supply power to the vehicle-side coil 11 and the resonant circuit 12 to predetermined power (a constant value).

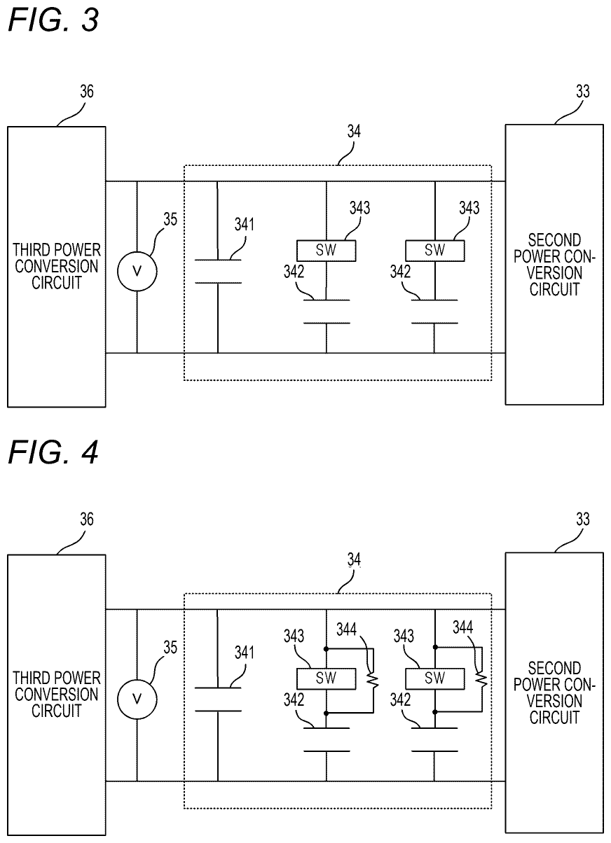

FIG. 3 is a diagram illustrating a configuration example of the variable capacitor 34, and illustrates a part of the power supply device 30 of FIG. 1 in an enlarged manner. As illustrated in FIG. 3, the variable capacitor 34 includes a first capacitor 341, at least one (two in the example of FIG. 3) second capacitor 342 provided in parallel to the first capacitor 341, and a switch 343 provided between the second capacitor 342 and a load connected to the third power conversion circuit 36.

The power supply-side control unit 40 changes the capacitance of the variable capacitor 34 by controlling the switch 343 to be turned on or off. In the example of FIG. 3, when two switches 343 are both turned on, a sum of a capacitance of the first capacitor 341 and a capacitance of each of two second capacitors 342 becomes the capacitance of the variable capacitor 34. When one of the two switches 343 is turned on and the other is turned off, the sum of the capacitance of the first capacitor 341 and the capacitance of one of the second capacitors 342 becomes the capacitance of the variable capacitor 34. When both of the two switches 343 are turned off, the capacitance of the first capacitor 341 becomes the capacitance of the variable capacitor 34.

For example, in an initial state, the power supply-side control unit 40 controls the two switches 343 to be turned off. In this initial state, when the vehicle-side control unit 20 executes the capacitance setting control, constant power is transmitted from the vehicle-mounted device 10 to the power supply device 30, the variable capacitor 34 is charged with the power, and the terminal voltage Vc increases. After the start of the capacitance setting control, the power supply-side control unit 40 acquires the information about the terminal voltage Vc of the variable capacitor 34 detected by the voltage detection circuit 35, and determines a change amount of the terminal voltage Vc (a gradient of the terminal voltage Vc over time). The power supply-side control unit 40 determines the capacitance of the variable capacitor 34 to be set during the power feeding control based on the change amount.

For example, when the change amount of the terminal voltage Vc is equal to or larger than a threshold value, the power supply-side control unit 40 controls the necessary number of switches 343 to be turned on in accordance with a magnitude of the change amount to increase the capacitance of the variable capacitor 34 to be larger than the capacitance in the initial state.

In the initial state, the two switches 343 may be controlled to be turned on. In this case, when the change amount of the terminal voltage Vc is smaller than the threshold value, the power supply-side control unit 40 controls the necessary number of switches 343 to be turned off in accordance with the magnitude of the change amount to reduce the capacitance of the variable capacitor 34 to be smaller than the capacitance in the initial state.

Alternatively, in the initial state, one of the two switches 343 may be controlled to be turned on. In this case, when the change amount of the terminal voltage Vc is equal to or larger than the threshold value, the power supply-side control unit 40 controls the switch 343, which is turned off, to be turned on to increase the capacitance of the variable capacitor 34 to be larger than the capacitance in the initial state. When the change amount of the terminal voltage Vc is smaller than the threshold value, the power supply-side control unit 40 controls the switch 343, which is turned on, to be turned off to reduce the capacitance of the variable capacitor 34 to be smaller than the capacitance in the initial state.

After the capacitance of the variable capacitor 34 is controlled in this manner, the vehicle-side control unit 20 executes the power feeding control.

As described above, according to the contactless power transmission system 100, the capacitance of the variable capacitor 34 during the power feeding control is determined based on the change amount of the terminal voltage of the variable capacitor 34 in the case where the predetermined power is transmitted from the vehicle-mounted device 10 to the power supply device 30 before the start of the power feeding control. Therefore, a change in the transfer function G(s) caused by an individual difference between the vehicle-mounted device 10 and the power supply device 30, a positional relationship between the vehicle-side coil 11 and the power supply-side coil 31, or the like can be absorbed by adjusting the capacitance of the variable capacitor 34, and optimum power transmission control can be executed.

Even when the capacitance of the variable capacitor 34 is appropriately determined in the capacitance setting control, the transfer function G(s) may vary during the execution of the power feeding control. For example, when a target current value output to the load is changed or when an external environment such as temperature changes, the value of the pole or the zero of the transfer function G(s) may be changed. Therefore, the power supply-side control unit 40 may monitor the terminal voltage Vc detected by the voltage detection circuit 35 during the execution of the power feeding control, and when the terminal voltage Vc varies greatly, the power supply-side control unit 40 may absorb such a change in the pole or the zero by changing the capacitance of the variable capacitor 34. In this way, it is possible to stably perform power transmission during the power feeding control.

As described above, when the capacitance of the variable capacitor 34 is changed during the power feeding control, it is preferable to provide a resistor 344 in parallel to the switch 343 in the variable capacitor 34 as illustrated in FIG. 4. By providing the resistor 344, it is possible to prevent an inrush current when the switch 343 is switched from OFF to ON, and it is possible to improve safety of the circuit.

In the present specification, at least the following matters are described. In the parentheses, the corresponding constituent elements and the like in the above embodiment are shown, but the present invention is not limited thereto.
(1) A power reception device (power supply device 30) including:
a power reception unit (power supply-side coil 31 and resonant circuit 32) configured to receive power transmitted from a power transmission device (vehicle-mounted device 10) by contactless power transmission;
a power supply unit (variable capacitor 34) configured to be allowed to be charged with power received by the power reception unit, and allowed to supply stored power to a load, a capacitance of the power supply unit being variable;
a detection unit (voltage detection circuit 35) configured to detect a terminal voltage of the power supply unit; and
a control unit (power supply-side control unit 40) configured to control the capacitance of the power supply unit based on a change amount of the terminal voltage detected by the detection unit.

According to (1), an optimum capacitance of the power supply unit can be determined based on the change amount of the terminal voltage of the power supply unit charged with the power transmitted from the power transmission device. As a result, it is possible to execute optimum power transmission control regardless of an individual difference, a mutual positional relationship, or the like between the power transmission device and the power reception device.
(2) The power reception device according to (1),
in which the power transmission device is configured to execute power feeding control for controlling supply power from the power transmission device to the power reception unit such that the terminal voltage (terminal voltage Vc) of the power supply unit comes to a target voltage, and
the control unit is configured to control the capacitance of the power supply unit during the power feeding control based on the change amount of the terminal voltage of the power supply unit in a case where predetermined power is transmitted from the power transmission device to the power reception device before the power transmission device executes the power feeding control.

According to (2), it is possible to execute optimum power transmission control regardless of an individual difference, a mutual positional relationship, or the like between the power transmission device and the power reception device.
(3) The power reception device according to (2),
in which the control unit is configured to control the capacitance of the power supply unit during the power feeding control such that the capacitance becomes a capacitance larger than a predetermined capacitance, in a case where the change amount of the terminal voltage is equal to or larger than a threshold value when the predetermined power is received while the capacitance of the power supply unit is controlled to the predetermined capacitance.

According to (3), it is possible to execute optimum power transmission control regardless of an individual difference, a mutual positional relationship, or the like between the power transmission device and the power reception device.
(4) The power reception device according to (2),
in which the control unit is configured to control the capacitance of the power supply unit during the power feeding control such that the capacitance becomes a capacitance smaller than a predetermined capacitance, in a case where the change amount of the terminal voltage is equal to or smaller than a threshold value when the predetermined power is received while the capacitance of the power supply unit is controlled to the predetermined capacitance.

According to (4), it is possible to execute optimum power transmission control regardless of an individual difference, a mutual positional relationship, or the like between the power transmission device and the power reception device.
(5) The power reception device according to any one of (1) to (4),
in which the control unit is configured to further control the capacitance of the power supply unit based on the terminal voltage of the power supply unit while the power feeding control is executed.

According to (5), even after the power feeding control is started, it is possible to appropriately control the capacitance of the power supply unit in accordance with a change in the transfer function of the system for charging the power supply, which can be changed depending on the state of the load, the external environment, or the like.
(6) The power reception device according to any one of (1) to (5),
in which the power supply unit includes a first capacitor (first capacitor 341), at least one second capacitor (second capacitor 342) provided in parallel to the first capacitor, and a switch (switch 343) provided between the load and the second capacitor, and
the control unit controls the capacitance of the power supply unit by controlling the switch to be turned on or off.
(7) The power reception device according to (6),
in which the power supply unit includes a resistor (resistor 344) provided in parallel to the switch.

According to (7), it is possible to prevent an inrush current when the capacitance of the power supply unit is changed during the execution of the power feeding control, and it is possible to improve safety.

What is claimed is:

1. A power reception device comprising:
a power reception unit configured to receive power transmitted from a power transmission device by contactless power transmission;
a power supply unit configured to be allowed to be charged with power received by the power reception unit, and allowed to supply stored power to a load, a capacitance of the power supply unit being variable;
a detection unit configured to detect a terminal voltage of the power supply unit; and
a control unit configured to control the capacitance of the power supply unit based on a change amount of the terminal voltage detected by the detection unit.

2. The power reception device according to claim 1,
wherein the power transmission device is configured to execute power feeding control for controlling supply power from the power transmission device to the power reception unit such that the terminal voltage of the power supply unit comes to a target voltage, and
the control unit is configured to control the capacitance of the power supply unit during the power feeding control, based on the change amount of the terminal voltage of the power supply unit in a case where predetermined power is transmitted from the power transmission device to the power reception device before the power transmission device executes the power feeding control.

3. The power reception device according to claim 2,
wherein the control unit is configured to control the capacitance of the power supply unit during the power feeding control such that the capacitance becomes a capacitance larger than a predetermined capacitance, in a case where the change amount of the terminal voltage is equal to or larger than a threshold value when the predetermined power is received while the capacitance of the power supply unit is controlled to the predetermined capacitance.

4. The power reception device according to claim 2,
wherein the control unit is configured to control the capacitance of the power supply unit during the power feeding control such that the capacitance becomes a capacitance smaller than a predetermined capacitance, in a case where the change amount of the terminal voltage is equal to or smaller than a threshold value when the predetermined power is received while the capacitance of the power supply unit is controlled to the predetermined capacitance.

5. The power reception device according to claim 2,
wherein the control unit is configured to further control the capacitance of the power supply unit based on the terminal voltage of the power supply unit while the power feeding control is executed.

6. The power reception device according to claim 1,
wherein the power supply unit includes a first capacitor, at least one second capacitor provided in parallel to the first capacitor, and a switch provided between the load and the second capacitor, and
the control unit controls the capacitance of the power supply unit by controlling the switch to be turned on or off.

7. The power reception device according to claim 6,
wherein the power supply unit includes a resistor provided in parallel to the switch.
